(19) United States
(12) Patent Application Publication
(10) Pub. No.: US 2010/0062253 A1
(43) Pub. Date: Mar. 11, 2010

(54) DUAL STAGE PROCESS FOR THE RAPID FORMATION OF PELLETS

(76) Inventors: David Egan, Clare (IE); Derek Norman Wright, Berkshire (GB); Gerald F. Flynn, Surrey (GB)

Correspondence Address: FROMMER LAWRENCE & HAUG, 745 FIFTH AVENUE- 10TH FL., NEW YORK, NY, 10151, US

(21) Appl. No.: 12/377,960

(22) PCT Filed: Aug. 13, 2007
(86) PCT No.: PCT/IB2007/053204

§ 371 Date: Aug. 21, 2009

(30) Foreign Application Priority Data
Aug. 11, 2006 (ZA) 2006/06674

(51) Int. Cl. B05D 5/00; B22F 9/10

(52) U.S. Cl. 428/402; 427/185; 427/248.1

(57) ABSTRACT

The invention relates to a process for the formation of pellets containing an ultra hard core coated with an encapsulating material, the process including the steps of suspending ultra hard core material in a flow of gas; contacting the ultra hard core material with encapsulating to form pellets, introducing the pellets into a rotating vessel and contacting the pellets with encapsulating material to form pellets of greater mass than the pellets introduced into the rotating vessel. The invention also relates to a pellet containing an ultra hard core coated with an encapsulating material whenever produced by a process as hereinbefore described.

### BACKGROUND OF THE INVENTION

This invention relates to a process for the formation of pellets. In particular this application relates to a dual stage process for the formation of pellets by coating a central core with a powder material.

The process has a broad range of applications ranging from pelletising diamond seeds for High Pressure High Temperature diamond synthesis to using pelletised ultra hard materials in cutting or abrading tools.

Many high technology cutting and abrading tools are conventionally manufactured from a suitable metal with grains of ultra hard material such as diamond or cubic boron nitride embedded in the metal forming the cutting or abrading components of the tools. One option in manufacturing such tools is to initially pelletise the ultra hard material in a layer of the metal and subsequently press or sinter a plurality of these pellets into the tool components.

The oil, gas and mining industries are projected to significantly increase their demand for pelletised ultra hard products in the future. In order to maximise profitability and respond to this demand it will be necessary to have an efficient volume production process for ultra hard pellet manufacture.

Currently there are 2 main methods described in the literature for forming pellets around a central core of ultra hard material. These methods can generically be called “rotating pan” and “fluidised bed”.

The first “rotating pan” method involves introducing the ultra hard core material, e.g. diamond seeds, into either a rotating inclined pan, a drum or any other rotating vessel, where the pellet can be built up by 1) spraying a slurry containing metal powder, binder and solvent (encapsulating or coating material) over the rotating diamond seeds or 2) the binder and solvent is/are sprayed separately and the metal powder then “sprinkled” over the rotating diamond seeds. Rotation of the pan separates the coated diamond seeds (emergent pellets) and allows time for removal of the solvent from the sprayed material to form a concentric jacket of encapsulating material which increases in volume as the process proceeds. This technique is efficient in terms of depositing encapsulating material and thus building up the pellet mass quickly. The difficulty with this method is that it is susceptible to agglomeration of the cores and/or early pellets in the initial stages of the process. Deposition rates must be very slow to avoid agglomeration. This increases the overall processing time and reduces the throughput of the process. Agglomeration reduces in severity after the emergent pellet has attained a critical size.

The consequence of the agglomeration is that the final pellets may have significant size distribution and may contain more than one core per pellet. This contributes to increased process time and cost.

The second method involves using a fluidised bed technique. In this method, the ultra hard cores, e.g. diamond seeds, are suspended in a flow of gas within a chamber, into which a fine suspension of binder, solvent and particulate material (e.g. metal powder) (the encapsulating material) is sprayed. Alternatively, the binder-solvent may be sprayed with separate powder addition. The emergent pellets are built up in volume proportional (non-linearly) to the residence time spent in the chamber. The advantage of this process is that the fluid bed allows a good separation of the core seeds and thereby ensures that a single core (diamond seed) is contained in each pellet while depositing encapsulating material at a reasonable rate.

The disadvantage of this technique is that the maximum deposition rate is relatively slow and when using a high density particulate encapsulating material e.g. Mo, W and WC, the increasing mass of the pellets presents difficulties in terms of the capabilities of the equipment to maintain the suspension. This can be addressed by increasing the capacity of the equipment but this is costly and impacts on the commercial viability of producing commercial volumes of material.

A need exists for a process for the formation of pellets containing an ultra hard core coated (encapsulated) with an encapsulating material which process allows for increased production rates of the pellets and/or improved quality yield of pellets so produced.

### SUMMARY OF THE INVENTION

According to the first aspect of the present invention there is provided a process for the formation of pellets containing a core coated with an encapsulating material, the process including the steps of:
suspending core material in a flow of gas;
contacting the core material with encapsulating material to form pellets,
introducing the pellets into a rotating vessel,
contacting the pellets with encapsulating material to form pellets of greater mass than the pellets introduced into the rotating vessel.

The encapsulating material used in the gas flow arrangement may be the same or different to the encapsulating material used in the rotating vessel.

Preferably the rotating vessel is a pan or a drum.

Essentially the solution to the problems described above is to combine the two techniques known in the art into a single process design. As such, the initial stages of the process involve a fluid bed approach to maximise the yield of pellets containing one core particle only e.g. diamond seeds. The pellets may be built up to a critical size volume (Vcrit) whilst remaining in a fluid suspension. When the pellets attain this critical size, the pellets are transferred to a rotating pan where the pellets form the (sub) core of the final pellet process. The pellets so produced have a volume significantly greater than the pellets as introduced and the risk of agglomeration is much reduced as the layer on the surface absorbs the spray more quickly and thus deposition rates may be increased. In addition, the weightier particles are less likely to be held together by surface tension of the spray.

According to a second aspect of the present invention there is provided a pellet containing a core coated with an encapsulating material whenever produced by a process as hereinbefore described.

### DESCRIPTION OF THE EMBODIMENTS

The process for the formation of pellets containing an ultra hard core coated with an encapsulating material includes the steps of:
suspending ultra hard core material in a flow of gas;
contacting the ultra hard core material with encapsulating material to form pellets,
introducing the pellets into a rotating vessel,
contacting the pellets with encapsulating material to form pellets of greater mass than the pellets introduced into the rotating vessel.

The core is preferably comprised of hard core material, most preferably ultra hard core material. The ultra hard core material may be selected from material comprising cubic boron nitride and diamond including natural and synthetic diamond, synthetic diamond including both High Pressure High Temperature (HPHT) and Chemical Vapour Deposition (CVD) synthetic diamond, coated or cladded diamond, boron carbide, boron suboxide or combinations thereof.

The ultra hard core material is preferably suspended in a chamber or work vessel which is preferably a fluidised bed granulating/encapsulating apparatus. The work vessel may be a fluidised bed granulating/encapsulating apparatus of the type having a material work area, a rotatable plate disposed immediately beneath the work area and means for conveying a gaseous fluid through the work area for fluidised circulation of charge material therewithin; the granulating apparatus being operated to generally individually fluidise the ultra hard core material within the work area. It will be appreciated, however, that such a particular arrangement does not lie central to the present invention.

The encapsulating material may be comprised of metal and/or ceramic powder, binder and/or solvent. The metal powder may be cobalt, copper, iron, bronze, tungsten carbide, nickel, tungsten metal, molybdenum, zinc, brass, silver, or a mixture of two or more thereof. The particle size is preferably greater than approximately 0.01 micrometers, preferably greater than 0.1 micrometer, more preferably greater than 0.2 micrometers, more preferably greater than 0.5 micrometers, more preferably greater than 1 micrometers, more preferably greater than 2 micrometers, more preferably greater than 4 micrometers and most preferably greater than 8 micrometers. The particle size of the metal and/or ceramic powder is less than approximately 500 micrometers, more preferably less than 450 micrometers, more preferably less than 350 micrometers, more preferably less than 300 micrometers and most preferably less than 250 micrometers.

The core material is preferably greater than 10 micrometers, more preferably greater than 20 micrometers, more preferably greater than 50 micrometers, more preferably greater than 100 micrometers, more preferably greater than 200 micrometers, more preferably greater than 400 micrometers and most preferably greater than 800 micrometers. The particle size of the ultra hard core material is less than approximately 5000 micrometers, more preferably less than 4500 micrometers, more preferably less than 3500 micrometers, more preferably less than 3000 micrometers and most preferably less than 2500 micrometers

Polyethylene glycol, liquid paraffin, glycerol, shelac, polyvinyl alcohol (PVA), polyvinyl butyral (PVB), cellulose or stearic acid are preferred as the binding agent and the solvent may be water and/or an organic solvent, preferably ethyl alcohol, trichloro-ethylene or isopropyl alcohol (IPA). The metal powder should comprise no greater than approximately 80%, preferably no greater than approximately 70%, preferably no greater than approximately 60%, preferably no greater than approximately 50%, by weight of a slurry and the binder should comprise no greater than approximately 30%, preferably no greater than approximately 25%, preferably no greater than approximately 20%, preferably no greater than approximately 15%, preferably no greater than approximately 10%, preferably no greater than approximately 5% of the weight of the metal powder in the slurry.

In addition, a hard phase may be added to the metal and/or ceramic powder to improve the wear resistance of the encapsulating material itself. This hard phase could be tungsten carbide (WC), particles of WC-cobalt cermet or any conventional ceramic hard phase such as silicon carbide (SiC), silicon nitride (SiN), alumina (Al₂O₃) etc. or mixture of any of these. As above, the size of these hard phases could range from 0.01 microns to 500 microns (micrometers).

In the preferred embodiment of the present method, the spraying of the encapsulating material is continued for a sufficient time to build the coating on each core to achieve a predetermined critical size (Vcrit). The average diametric dimension of each pellet may range up to, but no greater than, approximately 5, preferably no greater than 4, more preferably no greater than 2 times the average diametric dimension of the ultra hard cores. The plate of the fluidised bed granulating apparatus is preferably rotated throughout the course of the granulating operation to circulate the ultra hard cores within the material work area during fluidisation of the cores.

The pellets as produced are thereafter introduced into a rotating, preferably inclined pan, where the pellet can be built further up by 1) spraying a slurry containing metal and/or ceramic powder, binder and solvent (encapsulating material) over the rotating diamond seeds and/or 2) the binder and solvent is/are sprayed separately and the metal and/or ceramic powder then “sprinkled” over the rotating diamond seeds. Rotation of the pan allows time for reduction and possible removal of the solvent from the sprayed encapsulating material to form a concentric jacket of encapsulating material which increases in volume as the process proceeds. The pellets are preferably always wet to a degree; while additional solvent is removed as it is put on. For the avoidance of doubt, the material from the bed is first allowed to be slightly wet before adding powder, then as more solvent/binder is added there is a constant replenishment—hence removal of solvent.

The process according to the present invention results in significantly increased accretion rate in the pan method over use of the pan method alone. According to the teaching of the present invention, the diameter of the pellets can increase by 10 microns per hour, preferably 20 microns per hour, more preferably 50 microns per hour, more preferably 100 microns per hour, more preferably 150 microns per hour, more preferably 200 microns per hour, more preferably 300 microns per hour, more preferably 400 microns per hour, most preferably 450 microns per hour. This results in a much reduced process time in the pan coater and subsequent reduction in process costs.

This advantage is achieved by ensuring the pellets from the fluidised bed granulator are of sufficient volume (Vcrit) to ensure minimal agglomeration in the rotating pan coater in the initial stages, thereby allowing a faster build up rate.

The pelletised material has a broad range of applications including the pelletising of diamond seeds, preferably in the range 200-1500 microns, with particulate metal including but not limited to Co, Fe, Ni, W, Mn, Cu and Sn, ceramic, tungsten carbide powders and/or aggregates thereof.

The process according to the present invention provides a significant advantage in terms of cost of production of pellets and enables dense metal powders to be used in a commercially viable production process.

The invention will now be described with reference to the following non-limiting examples and figures in which:

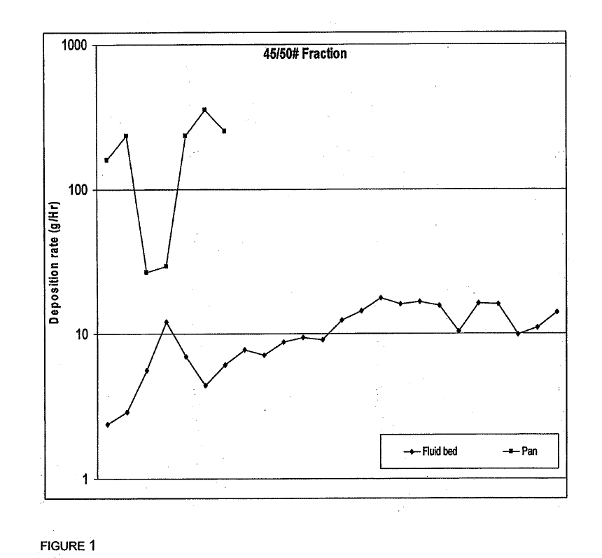

FIG. 1 is the progression of encapsulation rate for Example 2,

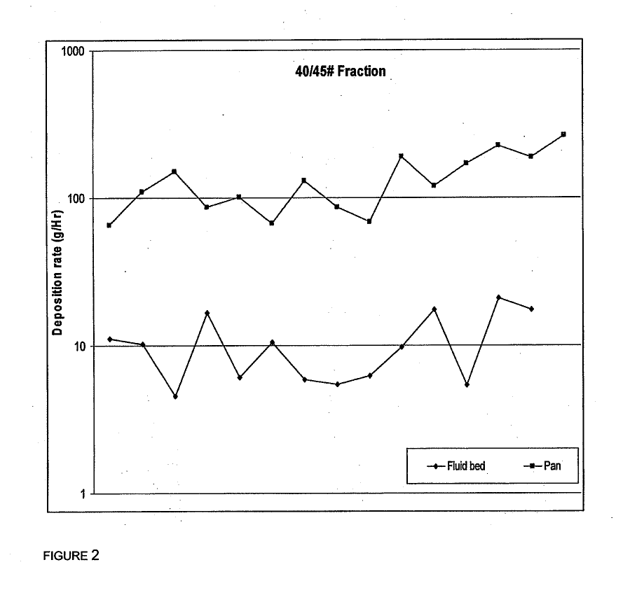

FIG. 2 illustrates the deposition rates for the 45/50# fraction,

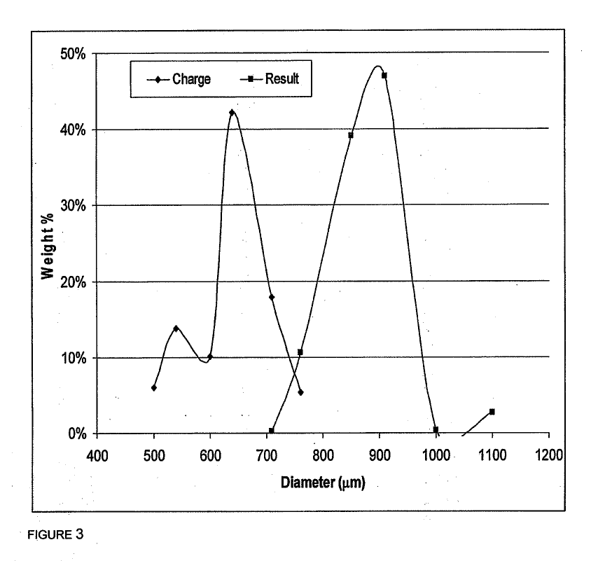

FIG. 3 illustrates the deposition rates for the 40/45# fraction,

FIG. 4 illustrates the size distribution of the charge of W/Mo encapsulated diamond and the result which was further encapsulated with Fe, and

### EXAMPLE 1

Diamond was encapsulated with a metal bond on a Dim-Net CT-3000D fluidised bed type diamond coating machine. A slurry was prepared by mixing equal weights (400 g) of bond powder (Umicore Cobalite-CNF) and water with 4 weight % (wt %) of the bond powder in PVA. 2,000 cts (400 g) of SDA100+TC 40/50# diamond was loaded in the coating machine.

The following settings were used:

| | Temp (° C.) | Fan |
|---|---|---|
| Inlet | 47 | 90/115 |
| Outlet | 28 | 65/115 |
| Pump | 3/10 | 1 mmØ tube |
| Spray | 1.75 | kgf/cm² |

This is the lowest spray rate of the pump, Eyla type MP-1000.

At these settings, the weight of the diamond was increased by 12 g in 120 minutes, this is a rate of 6 g/hr. There was no agglomeration obviously visible in the charge. The material was returned to the machine and encapsulation was continued at the following settings.

| | Temp (° C.) | Fan |
|---|---|---|
| Inlet | 53 | 100/115 |
| Outlet | 28 | 45/115 |
| Pump | 5/10 | 1 mmØ tube |
| Spray | 1.6 | kgf/cm² |

As can be seen from the table, the pumping rate was increased by 67%. At these settings, the weight of the diamond was increased by 30 g in 120 minutes, this is a rate of 15 g/hr. Some agglomeration was seen, this was separated and by weight was 7.25% of the total weight of the charge. This fraction was removed and the rest of the charge returned to the machine where encapsulation was continued at the following settings.

| | Temp (° C.) | Fan |
|---|---|---|
| Inlet | 53 | 100/115 |
| Outlet | 28 | 45/115 |
| Pump | 7/10 | 1 mmØ tube |
| Spray | 1.5 | kgf/cm² |

Spray rate for this test was further increased 40% (that is 130% above the first test). At these settings, the weight of the diamond was increased by 40 g in 90 minutes, this is a rate of 26.7 g/hr. More agglomeration was seen than before, this was separated and by weight was almost 30% of the total weight of the charge.

This example goes to show that using the fluidised bed system at a low rate can result in practically no agglomeration occurring, but, if the rate of deposition is increased too much in the initial stages then agglomeration can occur.

### EXAMPLE 2

In this example, a batch of E6 SDA1085 40/50 was to be increased in weight by 13.4 times by encapsulating with a 60 wt % W/40 wt % Mo metal powder mixture. Both powders had particle sizes less than 10 microns. Previous to this test, half the required powder amount had been built up on the diamond batch; this test was to complete a fraction to the required weight. 600 g of the partially completed batch was loaded on the same machine as described in Example 1 above.

The following settings were used for this test.

| | Temp (° C.) | Fan |
|---|---|---|
| Inlet | 53 | Max |
| Outlet | 29 | 70/115 to Max |
| Pump | 3/10 to Max | 0.8 mmØ tube |
| Spray | 2.0 | kgf/cm² |

Initially, the spray rate was kept low in case agglomeration resulted but it became clear that because the diamond already had a significant layer of metal powder, agglomeration was not going to be an issue.

At the start, 600 g of the material was charged on the machine but this was soon split into two batches as the machine, did not have the airflow capacity to keep this weight fluidised. The details of the runs are shown in Table 1 below. Every two runs, the batches were mixed and then split again to make sure that no single batch was coated more than the other.

TABLE 1
Details of runs for Example 2 on the fluidized bed machine.

| | | Starting | Finish | Weight | | Encap | |
|---|---|---|---|---|---|---|---|
| | | weight | weight | increase | Time | rate | Pump |
| | Batch | (g) | (g) | (g) | (hr) | (g/hr) | No. |
| Run 1 | | 600 | 604 | 4 | 0.75 | 5.3 | 3 |
| Run 2 | | 604 | 612 | 8 | 0.75 | 10.7 | 4 |
| Run 3 | | 610 | 618 | 8 | 1 | 8.0 | 4 |
| Run 4 | A | 300 | 310 | 10 | 1 | 10.0 | 5 |
| Run 5 | B | 312 | 332 | 20 | 2 | 10.0 | 5 |
| Run 6 | A | 318 | 322 | 4 | 0.5 | 8.0 | 5 |
| Run 7 | A | 322 | 342 | 20 | 1.75 | 11.4 | 5 |
| Run 8 | B | 314 | 344 | 30 | 3 | 10.0 | 7 |
| Run 9 | A | 316 | 346 | 30 | 2.25 | 13.3 | 10 |
| Run 10 | B | 344 | 358 | 14 | 1 | 14.0 | 10 |
| Run 11 | A | 344 | 368 | 24 | 2 | 12.0 | 10 |
| Run 12 | B | 358 | 384 | 26 | 1 | 26.0 | 10 |
| Run 13 | A | 368 | 388 | 20 | 1 | 20.0 | 10 |
| Run 14 | B | 384 | 408 | 24 | 1.5 | 16.0 | 10 |
| Run 15 | A | 388 | 408 | 20 | 1 | 20.0 | 10 |
| Run 16 | B | 408 | 422 | 14 | 1.5 | 9.3 | 10 |
| Run 17 | A | 408 | 418 | 10 | 1 | 10.0 | 10 |
| Run 18 | B | 422 | 430 | 8 | 1 | 8.0 | 10 |
| Run 19 | A | 418 | 434 | 16 | 2.5 | 6.4 | 10 |
| Run 20 | B | 430 | 442 | 12 | 1.25 | 9.6 | 10 |
| Run 21 | A | 434 | 438 | 4 | 1 | 4.0 | 10 |
| Run 22 | B | 442 | 446 | 4 | 0.75 | 5.3 | 10 |
| Run 23 | A | 438 | 444 | 6 | 1 | 6.0 | 10 |

FIG. 1 shows how the deposition rate changes as encapsulation progressed. It is clear that the deposition rate increases as the pumping rate is increased but then falls back even at the highest pumping level because the machine does not have the capacity to fluidise the material. This results in more material being dried into powder and extracted instead of being deposited on the charge.

### EXAMPLE 3

For this example, a Kalweka Pelletizer (Type-PLZ by Karnavati Engineering) rotating pan was used to build up more metal powder on the same partially encapsulated diamond as used in Example 2. For this example, 873 g of partially encapsulated diamond was placed on the rotating pan. The pan was angled at 45°±3° and rotated at 30 rpm which brought the partially encapsulated diamond up the pan, allowing it to fall back down again without it being held to the wall by centrifugal forces.

While the pan was rotating, metal powder was added to the charge by using a vibrating dispenser and at the same time spraying a binder solution onto the moving charge.

The metal powder added is the same as already on the charge, i.e. 60 wt % W/40 wt % Mo mixture. The binder which was sprayed was a 10 wt % PVA in water. A 5 wt % PVA solution was tried previously but this was not sufficient to allow continuous build-up. The rates at which the powder and binder are added will determine the overall build-up rate. If excess binder solution is sprayed, then the system will appear wet. Oppositely, if less binder is sprayed then it will appear dry. For this example, the system was purposely allowed to appear wet which reduced dust creation.

Encapsulation was continued for 165 minutes. In this time the weight of the charge was increased to 1432 g, that is a rate of 203.3 g per hour. If this is compared to Example 2, that is roughly a 10 fold increase in deposition rate. In addition, this weight of charge could not be fluidised by the fluid bed machine. In the final product, very little in agglomeration could be seen.

### EXAMPLE 4

For this example, the rotating pan which was used in the Example 3 was again utilised. 874 g of partially encapsulated diamond was placed on the rotating pan. The pan was angled at 45°±3° and rotated at 30 rpm. While the pan was rotating, metal powder (as Example 3) was added to the charge by using a vibrating dispenser and at the same time spraying a binder solution (as Example 3) onto the moving charge. For this example, the system was purposely allowed to appear dry, which did create dust. Encapsulation was continued for 205 minutes. In this time the weight of the charge was increased to 1450 g, that is a rate of 168.6 g per hour. If this is compared to Example 2, that is roughly again a 10 fold increase in deposition rate. In addition, this weight of charge could not be fluidised by the fluid bed machine.

### EXAMPLE 5

504 g (2520 cts) of SDA100+40/50 with a TiC coating was loaded in the rotating pan as described in Example 3. The pan was angled at 45° and rotated at 40 rpm. Binder solution was sprayed slowly while adding Umicore Cobalite-CNF slowly. The powder addition was measured at between 0.25 g and 0.5 g per minute. After an hour of encapsulating, the charge was removed and any agglomerates separated on a vibrating table. Almost 50% of the charge was not single particles. The actual weight increase was 28 g, corresponding to 28 g/hr. The work was halted at this stage, but it does show how difficult it is to prevent agglomeration on the rotating pan when starting with diamond without an initial encapsulated layer.

### EXAMPLE 6

This example was to increase 1200 cts (240 g) of 40/45# and 800 cts (160 g) 45/50# TiC coated E6 SDB diamond in weight by 10.9 times with an iron powder. The individual half sizes were encapsulated separately. Firstly, the iron was built-up in the fluid bed machine as described in Example 1. This was subsequently transferred to the rotating pan (as described in Example 3) to continue encapsulation. The following settings were used for this test.

| | Temp (° C.) | Fan |
|---|---|---|
| Inlet | 45 to 55 | 85 to Max |
| Outlet | 29 to 32 | 20 to 60 |
| Pump | 3 to 5 | 0.8 mmØ tube |
| Spray | 2.0 to 4.5 | kgf/cm² |

For the 800 cts (160 g) 45/50#fraction, the deposition rates are shown in the FIG. 2. As can be seen from this figure, there is again about a 10 fold increase in deposition rate on the pan when compared to the fluid bed. The drop in rate was because the powder preferentially granulated in the pan instead of encapsulating on the diamond. This was solved by using a more “sticky” binder solution of 15 wt % PVA. At each stage, agglomerates were separated by Sieving, at no time was there more than an estimated 5% particles which were not singular.

For the 1200 cts (240 g) 40/45#fraction, the deposition rates are shown in FIG. 3. As can be seen from this figure, there is again about a 10 fold increase in deposition rate on the pan when compared to the fluid bed. At each stage, agglomerates were separated by sieving, at no time was there more than an estimated 5% particles which were not singular.

Not only is the deposition rate faster on the rotating pan, but no slurry needs to be produced and using the machine is much simpler; i.e. there is no air heating, blocking of tubes etc. Overall, it took 17 days to build up on average 1.65 times the weight of starting diamond in iron powder on both half sizes. On the rotating pan, it took 11 days to build up the rest of the iron (9.25 times the original starting wt of the full size) to achieve the required 10.9 times increase. If the rotating pan was not used, conceivably it would have taken about another 100 days to build up the diamond to the required weight with iron if the material could have been fluidised. Certainly, batch splitting would have to be used.

### EXAMPLE 7

350 g of the same W/Mo partially encapsulated diamond was loaded onto the pan coater as described in Example 3. The pan was angled at 45° and rotated at 32 rpm. Onto the moving charge, iron powder, the same as used in Example 6 was added in a controlled manner while spraying a 15 wt % binder solution at the same time. As this was a test, the rates at which the powder and binder were added were conservative. Encapsulation was continued for about 1 hour which resulted in the weight increasing to 515 g. This is a rate of 165 g per hour. The median sizing of initial W/Mo partially encapsulated was 640 um, this was increased to a median of 900 um. The size distribution of the original charge and the resulting Fe encapsulated material is shown in the graph of FIG. 4 below. This example shows that it is possible to encapsulate more than one material on diamond.

1. A process for the formation of pellets containing a core coated with an encapsulating material, the process including the steps of:
suspending core material in a flow of gas;
contacting the core material with encapsulating material to form pellets,
introducing the pellets into a rotating vessel,
contacting the pellets with encapsulating material to form pellets of greater mass than the pellets introduced into the rotating vessel.

2. A process according to claim 1 wherein the rotating vessel is a pan or a drum.

3. A process according to either claim 1 wherein the core material is ultra hard core material.

4. A process according claim 3 wherein the ultra hard core material is selected from material comprising cubic boron nitride, diamond including natural and synthetic diamond, synthetic diamond including both High Pressure High Temperature (HPHT) and Chemical Vapour Deposition (CVD) synthetic diamond, and coated or cladded diamond, boron carbide, boron suboxide or combinations thereof.

5. A process according to claim 1 wherein the core material is suspended in a chamber or work vessel which is a fluidised bed granulating/encapsulating apparatus.

6. A process according to claim 5 wherein the work vessel is a fluidised bed granulating/encapsulating apparatus of the type having a material work area, a rotatable plate disposed immediately beneath the work area and means for conveying a gaseous fluid through the work area for fluidised circulation of charge material therewithin, the granulating apparatus being operated to generally individually fluidise the core material within the work area.

7. A process according to claim 1 wherein the encapsulating material is comprised of metal and/or ceramic powder, binder and/or solvent.

8. A process according to claim 7 wherein the metal and/or ceramic powder is cobalt, copper, iron, bronze, tungsten carbide, nickel, tungsten metal, molybdenum, zinc, brass, silver, or a mixture of two or more thereof.

9. A process according to claim 7 wherein a particle size of the metal and/or ceramic powder is greater than approximately 0.1 micrometers.

10. A process according to claim 7 wherein a particle size of the metal and/or ceramic powder is less than approximately 300 micrometers.

11. A process according to claim 7 wherein the binder is selected from polyethylene glycol, liquid paraffin, glycerol, shelac, polyvinyl alcohol (PVA), polyvinyl butyral (PVB), cellulose and/or stearic acid.

12. A process according to claim 7 wherein the solvent is water and/or an organic solvent.

13. A process according to claim 12 wherein the solvent is ethyl alcohol and/or trichloro-ethylene or isopropyl alcohol (IPA).

14. A process according to claim 7 wherein the metal and/or ceramic powder comprises no greater than approximately 80% by weight of a slurry.

15. A process according to claim 14 wherein the binder comprises no greater than approximately 30% of the weight of the metal and/or ceramic powder in the slurry.

16. A process according to claim 7 wherein a hard phase is added to the metal powder.

17. A process according to claim 16 wherein the hard phase is selected from tungsten carbide (WC), particles of WC-cobalt cermet or a conventional ceramic hard phase such as silicon carbide (SiC), silicon nitride (SiN), alumina (Al₂O₃) or mixture of any of these.

18. A process according to claim 16 wherein the size of the hard phase ranges from 0.1 microns to 500 microns.

19. A process according to claim 1 wherein spraying of the encapsulating material is continued for a sufficient time to build the coating on each core to achieve a predetermined critical size (Vcrit) wherein an average diametric dimension of each pellet may range up to, but no greater than, approximately 5 times the average diametric dimension of the ultra hard cores.

20. A process according to claim 1 wherein the pellets are introduced into a rotating pan, where the pellet can be built further up by:
spraying a slurry containing metal and/or ceramic powder, binder and solvent (encapsulating material) over the rotating diamond seeds; and/or
the binder and solvent is/are sprayed separately and the metal and/or ceramic powder then “sprinkled” over the rotating diamond seeds.

21. A process according to claim 1 wherein the diameter of the pellets increases by at least 10 microns per hour,

22. A pellet containing a core coated with an encapsulating material whenever produced by a process as hereinbefore described.
